(19) United States
(12) Patent Application Publication
(10) Pub. No.: US 2010/0278609 A1
(43) Pub. Date: Nov. 4, 2010

(54) SUPPORTIVE WELDED BOX SECTION COLLAR

(75) Inventor: Merton Palmer Wreford, Rochester Hills, MI (US)

Correspondence Address: Ford Global;c/o Shook, Hardy & Bacon L.L.P., Intellectual Property Department, 2555 Grand Blvd., Kansas City, MO, 64108, US

(73) Assignee: FORD GLOBAL TECHNOLOGIES, LLC, Dearborn, MI (US)

(21) Appl. No.: 12/433,936

(22) Filed: May 1, 2009

(51) Int. Cl. F16B 39/00

(52) U.S. Cl. 411/81

(57) ABSTRACT

A box section connector assembly includes a box section having a supportive weld collar positioned between the outer channel of the box section and the inner channel of the box section. The weld collar is fixedly attached to the inner channel. The weld collar includes a cylindrical body. The length of the cylindrical body is substantially equal to the distance between the inner side of the inner channel and the outer channel, thus the weld collar prevents the box section from being crushed upon attachment of the component to the box section by the bolt. In both embodiments the weld collar includes a flange which is attached to the outer side of the inner channel. In another embodiment the weld collar includes a shoulder which extends through an aperture formed through the outer channel in order to further locate both channels. A mechanical fastener such as a bolt is used to attach one or more attachable components to the box section.

### TECHNICAL FIELD

The disclosed invention relates generally to fasteners for a box section. More particularly, the disclosed invention relates to a supportive weld collar which allows a component to be bolted to a box section without the section collapsing

### BACKGROUND OF THE INVENTION

Box sections are used in a very wide variety of assembly applications. Ordinarily the result of two attached unshaped halves or channels, box sections are provided in, for example, vehicle construction. Frequently it is the case that a component must be attached to a box section. Sometimes this is done by welding. However, there are many instances (such when a component has to be detached for service) when such attachment is made by using fasteners such as bolts to attach the component to the box section.

In such a case the designer generally has two choices as to how to approach the attachment of the component to the box section. The first choice is to place a weld nut on the inside of the box on the side to be attached. Alternatively, the designer can add the weld nut to the outside of the box section on the opposite side to that being attached. A suitable hole must be provided on the attachment side to allow the bolt access to the nut.

Each of these approaches has its limitations. In the first instance the strength of the box section is not properly utilized. In the second instance it is possible to crush the box section on assembly. In general neither of these approaches utilizes the full strength of the box section but, instead, both approaches result in unwanted stresses on the joint between the box section and the joint.

Accordingly, as in so many areas of design, there is room for improvement and in this instant case an improved method of attaching a component to a box section is desired.

### SUMMARY OF THE INVENTION

The disclosed invention represents advancement in the art of attaching one component to another which overcomes limitations known in prior approaches. According to the disclosed invention, a box section connector assembly for attachment of a component includes a box section having an outer channel and an inner channel and a weld collar attached to the inner channel. The outer channel has an aperture formed therethrough and the inner channel has an aperture formed therethrough. The two apertures are aligned. The weld collar will normally have a cylindrical body.

In one embodiment of the disclosed invention the aperture on the outer channel is smaller than the aperture on the inner channel. In this embodiment the weld collar has a flange formed at one end. The flange is attached to the outer side of the inner channel by means such as welding.

In another embodiment the weld collar has a locating shoulder for fitting substantially through said aperture of said outer channel. The shoulder is used to locate the outer channel with respect to the inner channel. The cylindrical body of this embodiment is attached to the outer side of the inner channel also by means such as welding.

The cylindrical body of the weld collar may be threaded or unthreaded. If threaded a threaded bolt for attaching a component to the box section is provided. If unthreaded a self-threading bolt for attaching a component to the box section and forms a thread in the unthreaded weld collar upon insertion as is known in the art.

In either embodiment the outer channel has a pair of edges and the inner channel has a pair of edges. The pair of edges of the outer channel are substantially positioned within the pair of edges of the inner channel.

The length of the cylindrical body is substantially equal to the distance between the inner side of the inner channel and the outer channel. Because the cylindrical body of the weld collar of the disclosed invention bridges across the distance defined by the inner side of the inner channel and the outer channel the box section will not be crushed upon attachment of the self-threading bolt.

Other advantages and features of the invention will become apparent when viewed in light of the detailed description of the preferred embodiment when taken in conjunction with the attached drawings and the appended claims.

### BRIEF DESCRIPTION OF THE DRAWINGS

For a more complete understanding of this invention, reference should now be made to the embodiment illustrated in greater detail in the accompanying drawings and described below by way of examples of the invention wherein:

FIG. 1 illustrates a perspective view of a first embodiment of the disclosed invention with the box section shown partially broken away and with the attaching part and the self-threading bolt shown in spaced apart relation relative to the box section and the attaching part;

FIG. 2 illustrates a sectional view of the disclosed invention of FIG. 1 taken along lines 2-2;

FIG. 3 illustrates a perspective view of a second embodiment of the disclosed invention with the box section shown partially broken away and with the attaching part and the self-threading bolt shown in spaced apart relation relative to the box section and the attaching part; and

FIG. 4 illustrates a sectional view of the disclosed invention of FIG. 3 taken along lines 4-4.

### DETAILED DESCRIPTION OF THE PREFERRED EMBODIMENT

In the following figures, the same reference numerals are used to refer to the same components. In the following description, various operating parameters and components are described for one constructed embodiment. These specific parameters and components are included as examples and are not meant to be limiting.

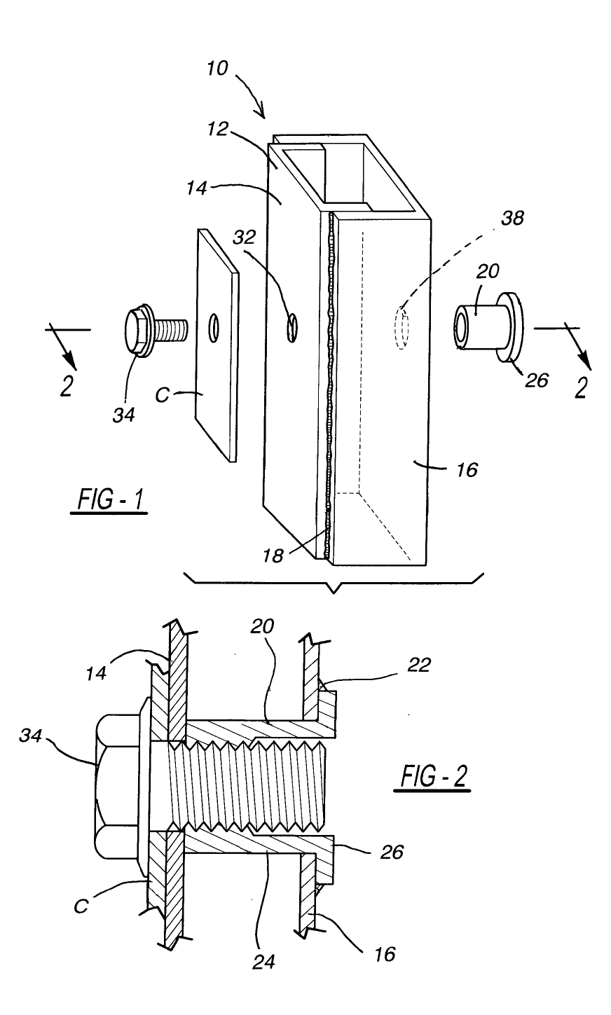

With reference to FIG. 1, a box section connector assembly according to one embodiment of the disclosed invention is shown and is generally illustrated as 10. The assembly 10 is shown in perspective view. FIG. 2 illustrates the box section connector assembly 10 in a cross section view taken along lines 2-2 of FIG. 1.

It is to be understood that the assembly 10 is shown for illustrative purposes only and is not intended as being limiting. The arrangement of the assembly 10 may be used in a broad variety of applications and may be employed anywhere a part is attached to a box section by a fastener. Accordingly, while use of the assembly 10 of the disclosed invention is suggested for use in vehicle applications it will readily find use in a broad variety of areas.

The assembly 10 includes a box section 12 having an outer channel 14 and an inner channel 16. The outer channel 14 and the inner channel 16 are attached to one another by, for example, one or more welds 18. Alternative methods of attachment known to those skilled in the art could well be used to attach the outer channel 14 and the inner channel 16.

A threaded weld collar 20 is attached to the outer surface of the inner channel 16. Attachment of the weld collar 20 to the outer surface of the inner channel 16 may be made by any one of several methods, although welding may be a preferred method. A suggested weld bead 22 is illustrated. On assembly, the threaded weld collar 20 is attached to the inner channel 16. While the illustrated weld collar 20 is threaded the weld collar 20 may alternatively be unthreaded.

The weld collar 20 includes a cylindrical body 24 having a flange 26 or similar structure which is attached to the outer surface of the inner channel 16. The length of the cylindrical body 24 is substantially equal to the distance between the inner wall of the inner channel 16 and the inner wall of the outer channel 14 when the two channels are assembled. Accordingly, the weld collar 20 bridges across the inside of the box section 12 as defined by the outer channel 14 and an inner channel 16.

A first bolt passing aperture 32 is formed in the outer channel 14. A fastener such as a bolt 34 (which may be self-threading if the weld collar is unthreaded) is used for anchoring a component, such as the plate C, to the box section 12. The plate C is only shown for illustrative purposes as a broad variety of parts may be attached to the box section 12 as is known in the art. In addition, the bolt 34 as shown is also provided only for illustrative purposes as many variations of bolts are known and may be adapted for the purposes described herein. A collar aperture 38 shown in broken lines is formed in the inner channel 16 through which the collar 20 is permitted to pass.

While the bolt 34 is illustrated it should be understood that other mechanical fasteners, such as a pop rivet, may be suitable for the disclosed invention. Accordingly, the illustrated bolt 34 is intended as being for illustrative purposes only and is not intended as being limiting.

In addition to providing an anchor for the bolt 34, the weld collar 20 functions to keep the outer channel 14 and the inner channel 16 a proper and constant distance apart both prior to and after attachment of the component C to the box section 12. The disclosed box section connector assembly 10 thus has several advantages over the known art, from improved simplicity of assembly to utilizing the complete sectional strength of the box section 12.

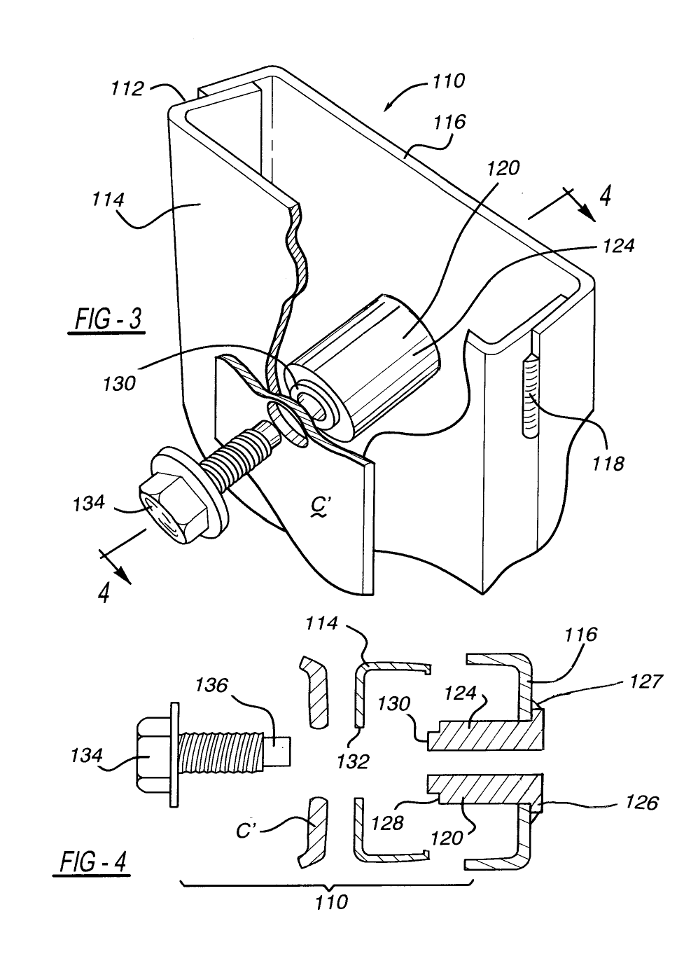

With reference to FIG. 3, a box section connector assembly according to an additional embodiment of the disclosed invention is shown in perspective view and is generally illustrated as 110. FIG. 4 illustrates the box section connector assembly 110 in a cross section view taken along lines 4-4 of FIG. 3.

It is to be understood that the second embodiment of the assembly 110 is shown for illustrative purposes only and is not intended as being limiting. As with the arrangement of the assembly 10 shown in FIGS. 1 and 2 and discussed in relation thereto, the arrangement of the assembly 110 may be used in a broad variety of applications and may be employed anywhere a part is attached to a box section by a fastener.

The assembly 110 includes a box section 112 having an outer channel 114 and an inner channel 116. The outer channel 114 and the inner channel 116 are attached to one another by, for example, one or more weld beads 118. Alternative methods of attachment known to those skilled in the art could well be used to attach the outer channel 114 and the inner channel 116.

A weld collar, such as an unthreaded weld collar 120, is attached to the outside surface of the inner channel 116. (The weld collar 120 may be threaded or unthreaded and the unthreaded type is shown here for non-limiting illustrative purposes.) On assembly, the unthreaded weld collar 120 is attached to the inner channel 116 prior to attachment of the outer channel 114 to the inner channel 116.

The unthreaded weld collar 120 includes a cylindrical body 124 having a flange 126 which is attached to the outside surface of the inner channel 116 (by, for example, a weld bead 127) and a second end 128 having a locating shoulder 130 formed thereon. The length of the cylindrical body 124 is substantially equal to the distance between the inner wall of the inner channel 116 and the inner wall of the outer channel 114 when the two channels are assembled. Accordingly, the unthreaded weld collar 120 bridges across the inside of the box section 112 as defined by the outer channel 114 and an inner channel 116. The locating shoulder 130 locates the inner channel 116 and the outer channel 114.

A first self-threading bolt passing aperture 132 is formed in the outer channel 114. A self-threading bolt 134 having a guide end 136 is used for anchoring a component, such as the plate C′, to the box section 112. The plate C′ is only shown for illustrative purposes as a broad variety of parts may be attached to the box section 112 as is known in the art. In addition, the self-threading bolt 134 as shown is also provided only for illustrative purposes as many variations of self-threading bolts are known and may be adapted for the purposes described herein. An aperture 138 is provided to allow the collar 120 to pass through the inner channel 116.

In addition to providing an anchor for the self-threading bolt 134, the unthreaded weld collar 120 functions to keep the outer channel 114 and the inner channel 116 a proper and constant distance apart both prior to and after attachment of the component C′ to the box section 112. Because the unthreaded weld collar 120 has the locating shoulder 130 to properly align the outer channel 114 relative to the inner channel 116 on assembly the use of location pins in the assembly jig is rendered unnecessary. The disclosed box section connector assembly 110 thus has several advantages over the known art, from improved simplicity of assembly to utilizing the complete sectional strength of the box section 112.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

What is claimed is:

1. A box section connector assembly for attachment of a component, the box section connector assembly comprising:
a box section having a first channel and a second channel, said second channel having an aperture;
a weld collar attached to said first channel, said weld collar having a locating shoulder for fitting into said aperture of said second channel; and
a fastener for insertion into said weld collar, said fastener providing an attachment point for the component.

2. The box section connector assembly of claim 1 wherein said weld collar is a threaded collar and said fastener is a threaded bolt.

3. The box section connector assembly of claim 1 wherein said weld collar is an unthreaded weld collar and wherein said fastener is a self-threading bolt.

4. The box section connector assembly of claim 1, wherein said first channel is an inner channel and wherein said second channel is an outer channel.

5. The box section connector assembly of claim 4 wherein said outer channel has a pair of edges and wherein said inner channel has a pair of edges, said pair of edges of said outer channel being substantially positioned within said pair of edges of said inner channel.

6. The box section connector assembly of claim 1 wherein said weld collar is attached to said first channel by welding.

7. The box section connector assembly of claim 1 wherein said weld collar has a first end, a second end, and a cylindrical wall located therebetween, said cylindrical wall having a length, and wherein said first channel has an inner surface and said second channel has an inner surface, said length of said cylindrical wall being substantially equal to the distance between said inner surface of said first channel and said inner surface of said second channel.

8. The box section connector assembly of claim 1 wherein said weld collar has an aperture formed therethrough and said first channel has an aperture formed therethrough, said aperture of said weld collar and said aperture of said first channel being aligned.

9. A box section connector assembly for attachment of a component, the box section connector assembly comprising:
a box section having a first channel and a second channel, said first channel having an inner surface and an aperture and said second channel having an inner surface and an aperture;
a weld collar attached to said first channel, said weld collar having a cylindrical wall, said cylindrical wall having a length, said length of said cylindrical wall being equal to or greater than the distance between said inner surface of said first channel and said inner surface of said second channel, said weld collar further having a first end, at least a portion of said first end abutting said inner surface of said second channel; and
a mechanical fastener for insertion into said weld collar, said mechanical fastener providing an attachment point for the component.

10. The box section connector assembly of claim 9 wherein said first channel has an outer surface, and wherein said weld collar has a second end, said second end including a flange, said flange being abutted against said outer surface of said first channel.

11. The box section connector assembly of claim 9 wherein said first end of said weld collar further includes a locating shoulder for fitting substantially into said aperture of said second channel.

12. The box section connector assembly of claim 9 wherein said first channel is an inner channel.

13. The box section connector assembly of claim 12 wherein said second channel is an outer channel.

14. The box section connector assembly of claim 13 wherein said outer channel has a pair of edges and wherein said inner channel has a pair of edges, said pair of edges of said outer channel being substantially positioned within said pair of edges of said inner channel.

15. The box section connector assembly of claim 9 wherein said weld collar is attached to said first channel by welding.

16. The box section connector assembly of claim 9 wherein said weld collar is threaded.

17. The box section connector assembly of claim 9 wherein said fastener is selected from the group consisting of a threaded bolt, a self-threading bolt, and a rivet.

18. A box section connector assembly for attachment of a component, the box section connector assembly comprising:
a box section having a first channel having an inner surface and an outer surface and a second channel having an inner surface and an outer surface, said first channel having a weld collar-passing aperture and said second channel having a fastener-passing aperture, said apertures being aligned;
a weld collar attached to said first channel, said weld collar having a first end, said first end being at least partially abutted against said inner surface of said second channel, said weld collar further having a second end, said second end including a flange, said flange being abutted against said outer surface of said first channel; and
a fastener for insertion into said weld collar, said fastener providing an attachment point for the component to said outer surface of said second channel.

19. The box section connector assembly of claim 18 wherein said first end of said weld collar further includes a locating shoulder for fitting substantially into said fastener-passing aperture of said second channel.

20. The box section connector assembly of claim 18 wherein said weld collar is an unthreaded collar and wherein said fastener is a self-threading bolt.
